(19) United States
(12) Patent Application Publication
(10) Pub. No.: US 2024/0399243 A1
(43) Pub. Date: Dec. 5, 2024

(54) METHOD FOR APPLYING TACTILE DYNAMIC EFFECT AND APPARATUS, STORAGE MEDIUM, AND ELECTRONIC DEVICE

(71) Applicant: AAC Acoustic Technologies (Shanghai) Co., Ltd., Shanghai (CN)

(72) Inventors: Liyi Zhou, Shanghai (CN); Xiuyue Wang, Shanghai (CN)

(21) Appl. No.: 18/406,258

(22) Filed: Jan. 8, 2024

Related U.S. Application Data
(63) Continuation of application No. PCT/CN2023/097937, filed on Jun. 2, 2023.

(51) Int. Cl. A63F 13/285; G06F 3/01

(52) U.S. Cl. CPC A63F 13/285; G06F 3/016

(57) ABSTRACT

Provided is a method and apparatus for applying tactile dynamic effect, a storage medium, and an electronic device. The method includes: acquiring a set relationship between object attributes and tactile dynamic effects; querying for a tactile dynamic effect corresponding to a current object attribute; and performing vibration according to the tactile dynamic effect corresponding to the current object attribute. When the object attribute changes, the tactile dynamic effect corresponding to the object attribute also changes, so that rich, three-dimensional and realistic tactile experience can be achieved based on the relationship between object attributes and tactile dynamic effects.

### TECHNICAL FIELD

The present disclosure relates to the technical field of electronics, and in particular, to a method and an apparatus for applying tactile dynamic effect, a storage medium, and an electronic device.

### BACKGROUND

With the development in the field of mobile games and virtual reality (VR) games, the interactive scenario is more and more focused on audio-visual and tactile experience, but the tactile experience in current interactive scenarios is relatively simple.

### SUMMARY

In view of the above, embodiments of the present disclosure provide a method and apparatus for applying tactile dynamic effect, a storage medium, and an electronic device, to achieve rich, three-dimensional and realistic tactile experience.

In one aspect, an embodiment of the present disclosure provides a method for applying tactile dynamic effect, including: acquiring a set relationship between object attributes and tactile dynamic effects; querying for a tactile dynamic effect corresponding to a current object attribute; and performing vibration according to the tactile dynamic effect corresponding to the current object attribute.

As an improvement, the object attribute is an archery parameter, and the archery parameter corresponds to one tactile dynamic effect.

As an improvement, the archery parameter includes a bowstring drawing degree.

As an improvement, a greater bowstring drawing degree indicates greater tactile vibration intensity corresponding to the tactile dynamic effect.

As an improvement, the object attribute is a vehicle motion parameter, and the vehicle motion parameter corresponds to a plurality of tactile dynamic effects.

As an improvement, the vehicle motion parameter includes an engine gauge.

As an improvement, the engine gauge corresponds to a tactile dynamic effect of acceleration, a tactile dynamic effect of natural deceleration, and a tactile dynamic effect of braking.

In another aspect, an embodiment of the present disclosure provides an apparatus for applying tactile dynamic effect, including: an acquisition module configured to acquire a set relationship between object attributes and tactile dynamic effects; a query module configured to query for a tactile dynamic effect corresponding to a current object attribute; and a vibration module configured to perform vibration according to the tactile dynamic effect corresponding to the current object attribute.

In another aspect, an embodiment of the present disclosure provides a storage medium including a program stored thereon, the program, when running, is configured to control a device where the storage medium is located to perform the method for applying tactile dynamic effect described as above.

In another aspect, an embodiment of the present disclosure provides an electronic device, including a memory and a processor, the memory is configured to store program instructions, and the processor is configured to control execution of the program instructions, when the program instructions are loaded and executed by the processor, steps of the method for applying tactile dynamic effect as described in claim 1 are implemented.

In the technical solution of the method for applying tactile dynamic effect provided in the present disclosure, the set relationship between object attributes and tactile dynamic effects is acquired; the tactile dynamic effect corresponding to the current object attribute is queried; and vibration is performed according to the tactile dynamic effect corresponding to the current object attribute. According to the present disclosure, when the object attribute changes, the tactile dynamic effect corresponding to the object attribute also changes, so that rich, three-dimensional and realistic tactile experience can be achieved based on the corresponding relationship between object attributes and tactile dynamic effects.

### BRIEF DESCRIPTION OF DRAWINGS

In order to illustrate the technical solutions in the embodiments of the present disclosure more clearly, the accompanying drawings required to be used in the embodiments will be briefly introduced below. It is appreciated that, the accompanying drawings in the following description are only some embodiments of the present disclosure. For those of ordinary skill in the art, other accompanying drawings can also be obtained based on these accompanying drawings without creative efforts.

FIG. 1 is a flowchart of a method for applying tactile dynamic effect according to an embodiment of the present disclosure;

FIG. 2 is a schematic diagram showing corresponding relationship between bowstring drawing degrees and tactile vibration intensity according to an embodiment of the present disclosure;

FIG. 3 is a schematic diagram showing another corresponding relationship between bowstring drawing degrees and tactile vibration intensity according to an embodiment of the present disclosure;

FIG. 4 is a schematic diagram showing corresponding relationship between an engine gauge and tactile vibration intensity according to an embodiment of the present disclosure;

FIG. 5 is a schematic diagram showing another corresponding relationship between an engine gauge and tactile vibration intensity according to an embodiment of the present disclosure;

FIG. 6 is a schematic structural diagram of an apparatus for applying tactile dynamic effect according to an embodiment of the present disclosure; and

FIG. 7 is a schematic diagram of an electronic device according to an embodiment of the present disclosure.

### DESCRIPTION OF EMBODIMENTS

In order to better understand the technical solutions of the present disclosure, embodiments of the present disclosure are described below in detail with reference to the accompanying drawings.

It should be clear that the described embodiments are only some but not all of the embodiments of the present disclosure. Based on the embodiments of the present disclosure, all other embodiments obtained by those of ordinary skill in the art without creative efforts fall within the protection scope of the present disclosure.

The terms used in the embodiments of the present disclosure are only for the purpose of describing specific embodiments and are not intended to limit the present disclosure. As used in the specification of the present disclosure and the appended claims, the singular forms of “a/an”, “said”, and “the” are intended to include plural forms, unless otherwise clearly specified in the context.

It should be understood that the term “and/or” used herein describes an association relationship between associated objects and represents that three relationships may exist. For example, A and/or B may represent the following three cases: only A exists, both A and B exist, and only B exists. In addition, the character “/” generally indicates an “or” relationship between the associated objects.

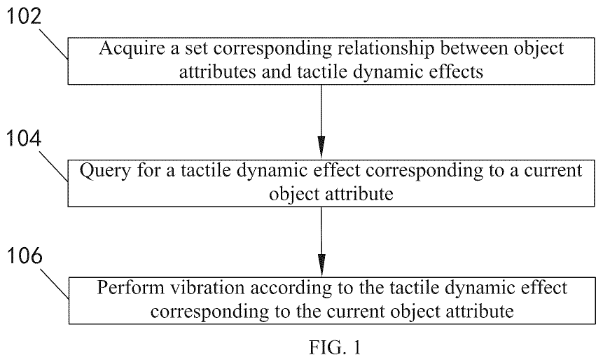

FIG. 1 is a flowchart of a method for applying tactile dynamic effect according to an embodiment of the present disclosure. As shown in FIG. 1, the method includes the following steps.

In step 102, a set corresponding relationship between object attributes and tactile dynamic effects is acquired.

In an embodiment of the present disclosure, a game or interactive application is run prior to step 102, each step is performed by an electronic device, and the electronic device includes a game controller, a mobile phone, a tablet computer, a wearable device, and the like. For example, the game controller includes a touch game controller, a VR controller, a Valve game controller, or a touch sense force (TSF) gamepad.

In an embodiment of the present disclosure, the corresponding relationship between object attributes and tactile dynamic effects may be set in advance. The object attributes may be interactive behavior parameters. When the interactive behavior parameters change, the tactile dynamic effects in the corresponding relationship also change, so that rich, three-dimensional and realistic tactile experience can be achieved.

In an embodiment of the present disclosure, the object attribute is an archery parameter, the archery parameter corresponds to one tactile dynamic effect, and the archery parameter includes a bowstring drawing degree.

In an embodiment of the present disclosure, a greater bowstring drawing degree indicates greater tactile vibration intensity corresponding to the tactile dynamic effect.

In an embodiment of the present disclosure, the object attribute is a vehicle motion parameter, the vehicle motion parameter corresponds to a plurality of tactile dynamic effects, and the vehicle motion parameter includes an engine gauge.

In an embodiment of the present disclosure, the engine gauge corresponds to a tactile dynamic effect of acceleration, a tactile dynamic effect of natural deceleration, and a tactile dynamic effect of braking.

In step 104, a tactile dynamic effect corresponding to a current object attribute is queried.

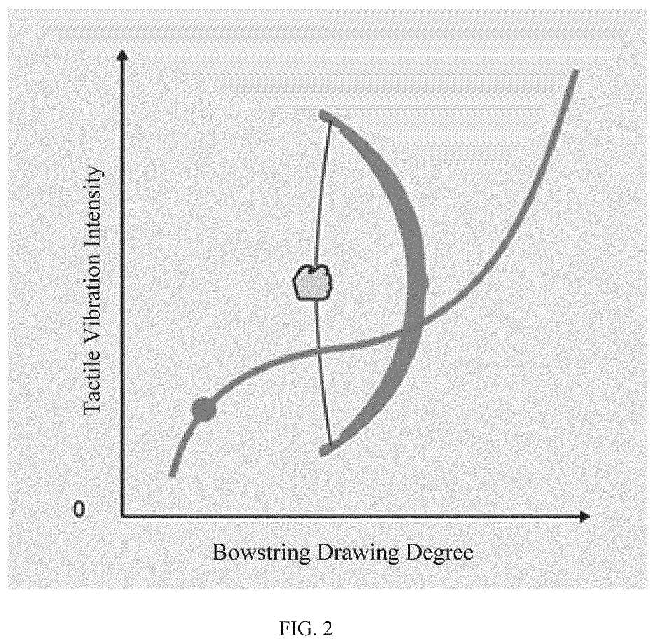

FIG. 2 is a schematic diagram showing corresponding relationship between bowstring drawing degrees and tactile vibration intensity according to an embodiment of the present disclosure. As shown in FIG. 2, the horizontal coordinate is the bowstring drawing degrees, and the vertical coordinate is the tactile vibration intensity. The point in the figure corresponds to a bowstring drawing degree as shown in the middle of FIG. 2. When the bowstring is not drawn far apart, a vibration touch thereof should be obvious but overall slight.

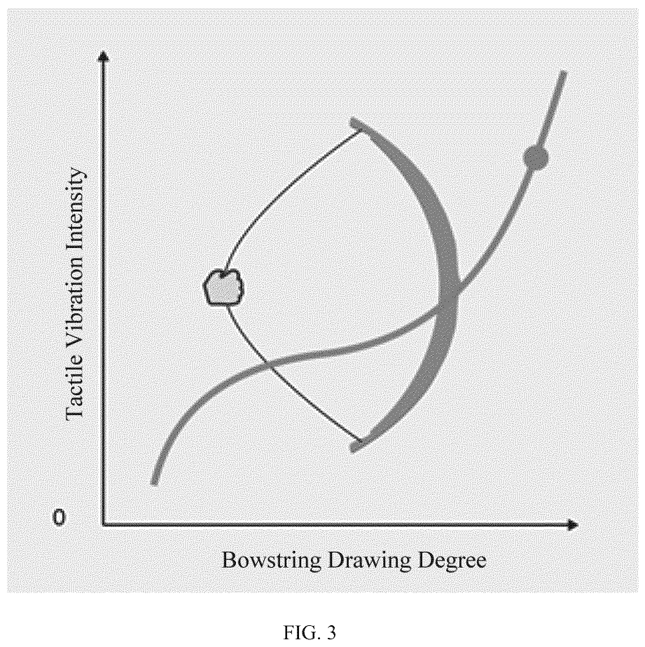

FIG. 3 is a schematic diagram showing another corresponding relationship between bowstring drawing degrees and tactile vibration intensity according to an embodiment of the present disclosure. As shown in FIG. 3, the horizontal coordinate is the bowstring drawing degrees, and the vertical coordinate is the tactile vibration intensity. The point in the figure corresponds to a bowstring drawing degree as shown in the middle of FIG. 3. When the bowstring is drawn farther apart, a vibration touch thereof becomes tighter and more intense.

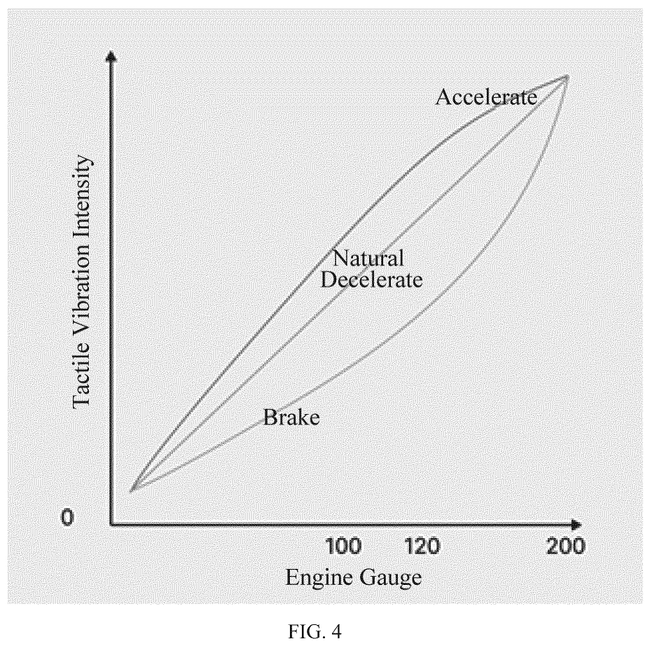

FIG. 4 is a schematic diagram showing corresponding relationship between an engine gauge and tactile vibration intensity according to an embodiment of the present disclosure. As shown in FIG. 4, the horizontal coordinate is the engine gauge, and the vertical coordinate is the tactile vibration intensity. The engine gauge corresponds to a curve A for a tactile dynamic effect of acceleration, a curve B for a tactile dynamic effect of natural deceleration, and a curve C for a tactile dynamic effect of braking.

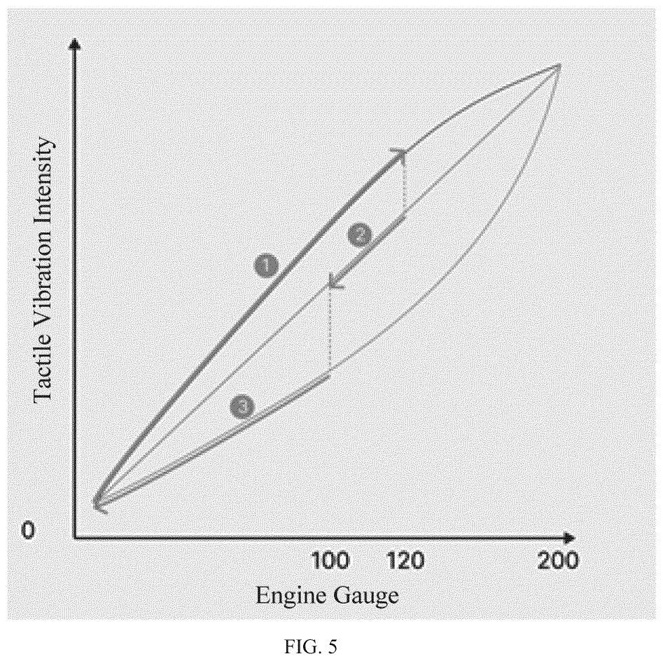

FIG. 5 is a schematic diagram showing another corresponding relationship between an engine gauge and tactile vibration intensity according to an embodiment of the present disclosure. As shown in FIG. 5, when a user presses and holds an accelerator to accelerate, vibration is performed through the tactile dynamic effect of the curve A. When the user releases the accelerator, a natural deceleration state is entered. The tactile dynamic effect of the curve B is switched to for vibration. When the user presses a brake, the tactile dynamic effect of the curve C is switched to for vibration. Assuming that the accelerator is accelerated to 120 km/h, the accelerator is released, and the brake is pressed to stop when the gauge is reduced to 100, the vibration is performed according to the tactile dynamic effect as shown in FIG. 5 in accordance with an arrow sequence of a line segment 1 in the curve A, a line segment 2 in the curve B, and a line segment 3 in the curve C.

In step 106, vibration is performed according to the tactile dynamic effect corresponding to the current object attribute.

In the technical solution provided in this embodiment, based on the corresponding relationship between object attributes and tactile dynamic effects, the interactive experience becomes more vivid, which can help the user become more immersive when experiencing dynamic games.

In the technical solution provided in this embodiment, the set corresponding relationship between object attributes and tactile dynamic effects is acquired; the tactile dynamic effect corresponding to the current object attribute is queried; and vibration is performed according to the tactile dynamic effect corresponding to the current object attribute. According to the present disclosure, when the object attribute changes, the tactile dynamic effect corresponding to the object attribute also changes, so that rich, three-dimensional and realistic tactile experience can be achieved based on the corresponding relationship between object attributes and tactile dynamic effects.

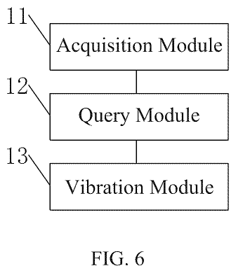

An embodiment of the present disclosure provides an apparatus for applying tactile dynamic effect. FIG. 6 is a schematic structural diagram of an apparatus for applying tactile dynamic effect according to an embodiment of the present disclosure. As shown in FIG. 6, the apparatus includes: an acquisition module 11, a query module 12, and a vibration module 13.

The acquisition module 11 is configured to acquire a set corresponding relationship between object attributes and tactile dynamic effects.

The query module 12 is configured to query for a tactile dynamic effect corresponding to a current object attribute.

The vibration module 13 is configured to perform vibration according to the tactile dynamic effect corresponding to the current object attribute.

In an embodiment of the present disclosure, the object attribute is an archery parameter, and the archery parameter corresponds to one tactile dynamic effect.

In an embodiment of the present disclosure, the archery parameter includes a bowstring drawing degree.

In an embodiment of the present disclosure, a greater bowstring drawing degree indicates greater tactile vibration intensity corresponding to the tactile dynamic effect.

In an embodiment of the present disclosure, the object attribute is a vehicle motion parameter, and the vehicle motion parameter corresponds to a plurality of tactile dynamic effects.

In an embodiment of the present disclosure, the vehicle motion parameter includes an engine gauge.

In an embodiment of the present disclosure, the engine gauge corresponds to a tactile dynamic effect of acceleration, a tactile dynamic effect of natural deceleration, and a tactile dynamic effect of braking.

In the technical solution provided in this embodiment, the set corresponding relationship between object attributes and tactile dynamic effects is acquired; the tactile dynamic effect corresponding to the current object attribute is queried; and vibration is performed according to the tactile dynamic effect corresponding to the current object attribute. According to the present disclosure, when the object attribute changes, the tactile dynamic effect corresponding to the object attribute also changes, so that rich, three-dimensional and realistic tactile experience can be achieved based on the corresponding relationship between object attributes and tactile dynamic effects.

The tactile dynamic effect application apparatus provided in this embodiment may be configured to implement the method for applying tactile dynamic effect in FIG. 1 above. Specific description may be obtained with reference to the embodiments of the tactile dynamic effect application above. Details are not described herein again.

An embodiment of the present disclosure provides a storage medium. The storage medium includes a stored program. The program, when running, controls a device where the storage medium is located to perform steps in the embodiments of the method for applying tactile dynamic effect described above. Specific description may be obtained with reference to the embodiments of the tactile dynamic effect application above.

An embodiment of the present disclosure provides an electronic device, including a memory and a processor. The memory is configured to store information including program instructions, and the processor is configured to control execution of the program instructions. When the program instructions are loaded and executed by the processor, steps of the method for applying tactile dynamic effect described above are implemented. Specific description may be obtained with reference to the embodiments of the tactile dynamic effect application above.

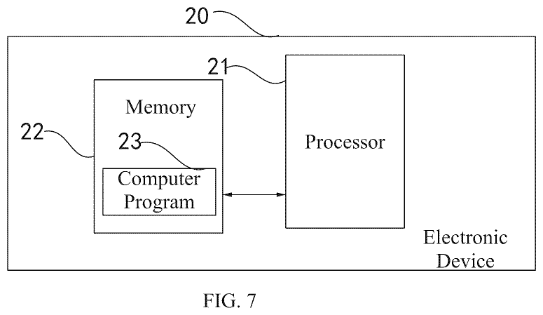

FIG. 7 is a schematic diagram of an electronic device according to an embodiment of the present disclosure. As shown in FIG. 7, an electronic device 20 in this embodiment includes: a processor 21, a memory 22, and a computer program 23 stored in the memory 22 and executable by the processor 21. When the computer program 23 is executed by the processor 21, the application method applied to tactile dynamic effects in the embodiments is implemented. Details are not described herein so as to avoid repetition. Alternatively, when the computer program is executed by the processor 21, functions of models/units in the application apparatus applied to tactile dynamic effects in the embodiments are implemented. Details are not described herein so as to avoid repetition.

The electronic device 20 includes, but is not limited to, the processor 21 and the memory 22. Those skilled in the art may understand that, FIG. 7 is only an example of the electronic device 20 and does not constitute any limitation on the electronic device 20, which may include more or fewer components than those illustrated, or integrate some components, or include different components. For example, the electronic device may also include an input/output device, a network access device, a bus, and the like.

The processor 21 referred to may be a central processing unit (CPU), or may be another general-purpose processor, a digital signal processor (DSP), an application-specific integrated circuit (ASIC), a field-programmable gate array (FPGA) or another programmable logic device, a discrete gate or a transistor logic device, a discrete hardware component, or the like. The general-purpose processor may be a microprocessor, or the processor may be any conventional processor or the like.

The memory 22 may be an internal storage unit of the electronic device 20 such as a hard disk or memory of the electronic device 20. The memory 22 may also be an external storage device of the electronic device 20, such as a plugged hard disk provided on the electronic device 20, a smart media card (SMC), a secure digital (SD) card, a flash card, or the like. Further, the memory 22 may also include both an internal storage unit and an external storage unit of the electronic device 20. The memory 22 is configured to store computer programs and other programs and data required by the electronic device. The memory 22 may also be configured to temporarily store data that has been or will be outputted.

It may be clearly understood by those skilled in the art that, for the purpose of convenient and brief description, detailed operating processes of the system, apparatus, and unit described above may be obtained with reference to the corresponding process in the foregoing method embodiments. Details are not described herein again.

In the several embodiments provided in the present disclosure, it should be understood that the disclosed system, apparatus, and method may be implemented in other manners. For example, the apparatus embodiments described above are merely an example. For example, the division of units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or in other forms.

The units described as separate parts may be or may not be physically separate, and parts displayed as units may be or may not be physical units, may be located at one position, or may be distributed on a plurality of network units. Some or all of the units may be selected based on actual requirements to achieve the objective of the solution of the embodiments.

In addition, functional units in the embodiments of the present disclosure may be integrated into one processing unit, or each of the units may physically exist alone, or two or more units are integrated into one unit. The integrated unit may be implemented in a form of hardware or in a form of hardware together with a software function unit.

The integrated unit implemented in the form of the software function unit may be stored in a computer-readable storage medium. The software function unit is stored in a storage medium, and includes several instructions for instructing a computer device (which may be a personal computer, a server, a network apparatus, or the like) or a processor to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely preferred embodiments of the present disclosure, but are not intended to limit the present disclosure. Any modification, equivalent replacement, improvement, and the like made within the spirit and principle of the present disclosure shall fall within the protection scope of the present disclosure.

What is claimed is:

1. A method for applying tactile dynamic effect, comprising:
acquiring a set relationship between object attributes and tactile dynamic effects;
querying for a tactile dynamic effect corresponding to a current object attribute; and
performing vibration according to the tactile dynamic effect corresponding to the current object attribute.

2. The method as described in claim 1, wherein the object attribute is an archery parameter, and the archery parameter corresponds to one tactile dynamic effect.

3. The method as described in claim 2, wherein the archery parameter comprises a bowstring drawing degree.

4. The method as described in claim 3, wherein a greater bowstring drawing degree indicates greater tactile vibration intensity corresponding to the tactile dynamic effect.

5. The method as described in claim 1, wherein the object attribute is a vehicle motion parameter, and the vehicle motion parameter corresponds to a plurality of tactile dynamic effects.

6. The method as described in claim 5, wherein the vehicle motion parameter comprises an engine gauge.

7. The method as described in claim 6, wherein the engine gauge corresponds to a tactile dynamic effect of acceleration, a tactile dynamic effect of natural deceleration, and a tactile dynamic effect of braking.

8. An apparatus for applying tactile dynamic effect, comprising:
at least one processor; and
a memory configured to store instructions executable by the at least one processor;
wherein the instructions cause the at least one processor to:
acquire a set relationship between object attributes and tactile dynamic effects;
query for a tactile dynamic effect corresponding to a current object attribute; and
perform vibration according to the tactile dynamic effect corresponding to the current object attribute.

9. A storage medium, comprising a program stored thereon, wherein the program, when running, is configured to control a device where the storage medium is located to perform the method for applying tactile dynamic effect as described in claim 1.
